(19) United States
(12) Patent Application Publication
(10) Pub. No.: US 2016/0096161 A1
(43) Pub. Date: Apr. 7, 2016

(54) METHOD OF CONVERSION OF ALKANES TO ALKYLENES AND DEVICE FOR ACCOMPLISHING THE SAME

(71) Applicant: William Curtis Conner, JR., Montague, MA (US)

(72) Inventor: William Curtis Conner, JR., Montague, MA (US)

(21) Appl. No.: 14/867,964

(22) Filed: Sep. 28, 2015

Related U.S. Application Data
(60) Provisional application No. 62/059,293, filed on Oct. 3, 2014.

(51) Int. Cl. B01J 19/12

(52) U.S. Cl. CPC B01J 19/126; B01J 2219/0871; B01J 2219/1215; B01J 2219/0892; B01J 2219/1248; B01J 2219/1227

(57) ABSTRACT

Disclosed herein is a method comprising disposing a catalyst composition in a device that comprises a radiation cavity; a tube having an inlet and an outlet disposed in the radiation cavity; where the catalyst composition is disposed in the tube and comprises a transition metal disposed on a support; where the radiation cavity is operative to subject the catalyst composition to microwave radiation, radio frequency radiation, or a combination thereof; introducing an alkane such as methane into the inlet end of the tube; and obtaining an alkylene such as ethylene at the outlet end of the tube.

This application claims priority to provisional application 62/059,293 filed Oct. 3 2014.

### BACKGROUND

This disclosure relates to a method of conversion of methane to larger hydrocarbons and hydrogen and to a device for accomplishing the same. In particular, this disclosure relates to a process and device for an efficient method of conversion of methane to olefins, aromatics and gaseous hydrogen and to a device for accomplishing the same.

Current methods of conversion of methane to olefins with significant selectivity to specific products use reactor temperatures greater than 1000° C. These temperatures are extreme and the process used to effect the conversion is energy intensive. It is desirable to effect the conversion at lower reactor temperatures and thus potentially to increase the product selectivity and to reduce the energy consumed in the process.

### SUMMARY

Disclosed herein is a method comprising disposing a catalyst composition in a device that comprises a radiation cavity; a tube having an inlet and an outlet disposed in the radiation cavity; where the catalyst composition is disposed in the tube and comprises a transition metal disposed on a support with lower susceptibility to microwave heating; where the radiation cavity is operative to subject the catalyst composition to microwave radiation; introducing an alkane such as methane into the inlet end of the tube; and obtaining an alkylene at the outlet end of the tube at significant selectivity.

Disclosed herein too is a device comprising a microwave radiation cavity; a tubular reactor having an inlet and an outlet disposed in the microwave radiation cavity; where a catalyst composition is disposed in the tubular reactor and where the catalyst composition comprises a transition metal disposed on a support; where the radiation cavity is operative to subject the catalyst composition to microwave radiation; a microwave susceptible heating media section disposed inside the tubular reactor; and a radiation choke disposed between the microwave radiation cavity and the tubular reactor; where the radiation choke is effective to prevent radiation leakage from the device.

### BRIEF DESCRIPTION OF THE FIGURES

FIG. 1 depicts an exemplary embodiment of a device that may be used in the conversion of alkanes to alkylenes; and

FIG. 2 depicts another exemplary embodiment of a device that may be used in the conversion of alkanes to alkylenes.

### DETAILED DESCRIPTION

Disclosed herein is a method of conversion of alkanes such as methane to alkylenes that uses reactor temperatures that are at least 100K lower than processes that are currently disclosed in the literature. The method uses exposure to microwave radiation to effect the conversion from methane to “higher” hydrocarbons and to hydrogen at lower measured reactor temperatures.

The method comprises flowing methane to a reactor that contains a transition metal supported on a metal oxide (e.g., silica, alumina, titania, and the like.) support. Microwave radiation may be used to selectively heat portions of the catalyst. The heating of the catalyst by microwave radiation promotes the methane to be efficiently converted to an alkylene or other higher hydrocarbon at a significantly lower temperature and/or with higher selectivity than in other conventional processes detailed elsewhere. The method of using radiation permits the use of reactor and gas-phase temperatures that are lower than those used in other conventional processes.

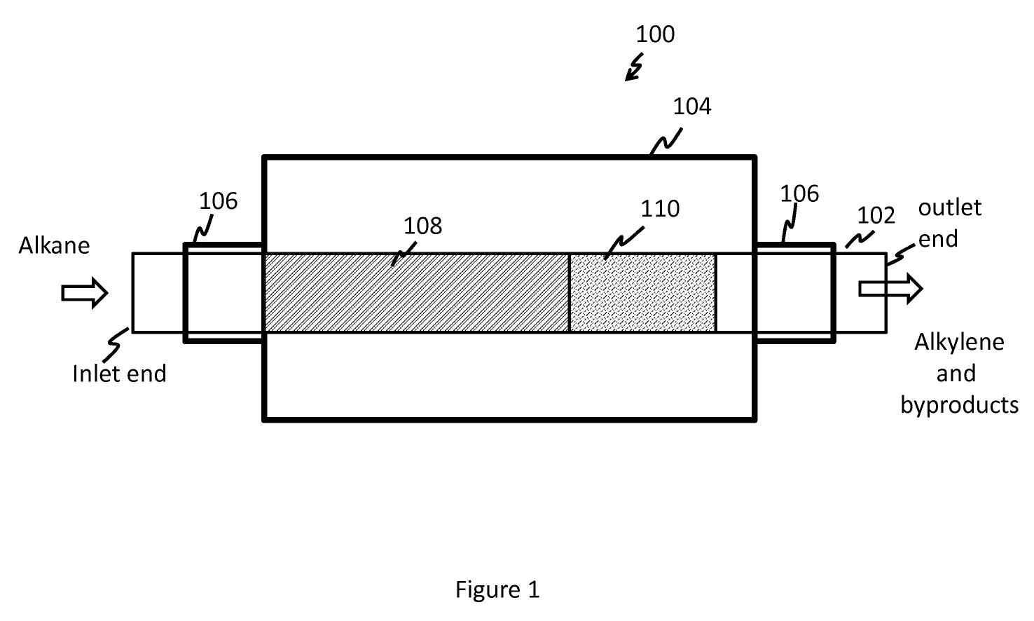

FIG. 1 depicts an exemplary embodiment of a device 100 that may be used in the conversion of methane to olefins and other hydrocarbons. The device comprises a microwave radiation cavity into which is inserted a reactor tube 102 that functions to transport the reaction gases from the inlet end of the tube to the outlet end of the tube. The tube is inert to the radiation, i.e., it does not interact with the radiation and is not affected significantly by the radiation. A radiation transfer barrier 106 such as a microwave choke is present at the points where the tube enters and exits the radiation cavity. These radiation barriers function to prevent radiation from leaking from the radiation cavity. Disposed inside the tube in this exemplary schematic is a heating media section 108 that functions to effectively heat incoming gases (e.g., the methane containing stream) to a predetermined temperature. A catalyst bed 110 disposed inside the tube within the microwave radiation cavity facilitates the conversion of the incoming gas into a desired product along with byproducts.

The radiation cavity is fitted with a source (not shown) in order to introduce the radiation into the radiation cavity. The source may be a magnetron or other microwave generating device that can introduce microwave radiation or radio frequency radiation into the cavity. The magnetron may produce radiation in the radio frequency range (3 kilohertz to 300 megahertz) and/or in the microwave frequency range (300 megahertz to 300 gigahertz). The radiation cavity is capable of using the microwave or radio frequency radiation as either a travelling wave or as a standing wave or it might actually operate as an oven with a variable distribution of high frequency energy or energies.

In an exemplary embodiment, microwave radiation having a frequency in the 1 to 10 gigahertz range may be used to effect the conversion of the methane to the desirable products. The magnetron may provide microwave radiation at a power of 10 watts to 50,000 watts, preferably 100 watts to 30,000 watts and more preferably 250 watts to 20,000 watts.

The inner reaction tube has an inlet through which methane and other desirable inert gases are introduced into the device and an exit through which olefin products and other desirable hydrocarbons and byproducts may be removed from the device. The tube is inserted into the radiation cavity in a tubular section. The tube is manufactured from a material that is essentially inert to the radiation or to the reactants, products or byproducts that are conducted in it. The tube material can also withstand reaction temperatures without undergoing deformation or destruction.

The tube is also fitted with an optional heating media section 108 and a catalyst bed 110. The heating media section contains media that can be used to preheat the reactants before they undergo reaction over the catalyst bed. The heating media section is used to heat the reactants to a temperature from which it may be heated by the radiation over the catalyst bed to undergo the desired reaction.

The heating media section 108 contains materials that can be heated by other modes of thermal heating (e.g., conduction or convection) in addition to being heated by higher frequency radiation. The heating media is preferably porous so that the reactants can pass through the pores and be heated efficiently. It is also desirable for the heating media not to react with the reactants of with the byproducts of the reaction within the tube.

Examples of the heating media are metallic or other powders or supported metals that readily absorb microwave or higher frequency radiation and transfer the radiation into heat. These media include many carbons, silicon or other carbides and a spectrum of other solids that exhibit strong absorption of the high frequency radiation.

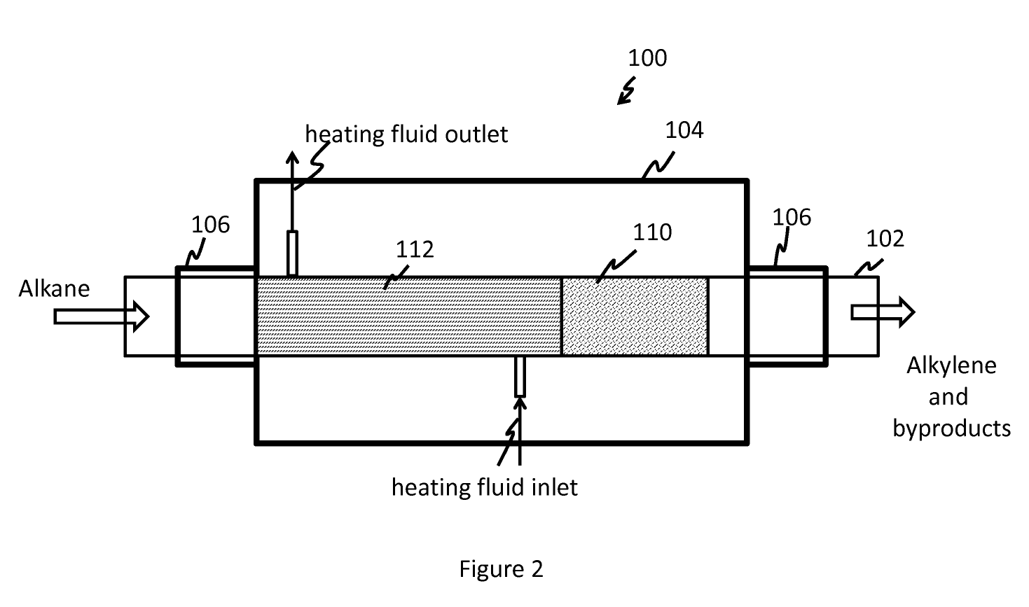

In another embodiment, the heating section may include a heat exchanger 112 through which the reactants travel prior to contacting the catalyst bed. This is shown in the FIG. 2, where the heat exchanger 112 comprises pipes through which a heating fluid is transported. The reactants (e.g., the alkanes) travel outside of the pipes and are heated by the heating fluid that is transported on the inside of the pipes. This may also be the gaseous product effluent from the reactor section.

It is to be noted that the heating media section and/or the heat exchanger is optional especially if the radiation by itself is capable of facilitating the conversion of methane to alkylenes without any preheating of the reaction gases.

When a heating media section and/or a heat exchanger (including a feed-effluent heat exchanger) is used, the reaction gases may be heated to a temperature of greater than or equal to 400° C., and preferably to a temperature of greater than or equal to 500° C. and more to a temperature of greater than or equal to 600° C. prior to contact with the catalyst section.

The catalyst bed uses a catalyst composition that comprises a metallic catalyst that is disposed on a catalyst support. It is desirable for the catalyst metal to be heated by the radiation. Examples of the transition metal include iron, nickel, cobalt, titanium, vanadium, chromium, copper, zinc, molybdenum, platinum, tantalum, niobium, gold, silver, palladium, iridium, or the like, or a combination thereof. Preferred transition metals are iron, nickel, cobalt, or alloys thereof. Alloys that include iron, nickel and cobalt and other transition metals or non-transition metals may also be used as catalysts.

The support is preferably a porous metal oxide, a porous carbonaceous support, or the like. It is desirable for the support to have pores into which the metal catalyst can reside. The metal can therefore reside on the surface of the support or within the pores of the support. The support can be alumina, silica, zirconia, titania, magnesia, or other transition metal oxides such as manganese, cerium, lanthanum, or the like, or a combination thereof.

It is desirable for the porous support to have a surface area of 0.5 to 1500 square meters per gram, preferably 0.75 to 900 square meters per gram and more preferably 1.0 to 500 square meters per gram.

The weight of the metal catalyst is 0.25 to 25 weight percent (wt %), preferably 0.5 to 10 wt % and more preferably 1.0 to 3 wt % based on the total weight of the catalyst composition, which includes the metal catalyst and the catalyst support.

In an exemplary embodiment, the catalyst composition comprises lattice-confined single iron sites embedded in a silica matrix. This catalyst is obtained by fusing ferrous metasilicate with silica at temperatures of 1900 to 2100 degrees Kelvin and from commercial quartz, followed by leaching with aqueous nitric acid and drying at 353 degrees Kelvin. The catalyst contains 0.5 wt % iron and has a Brunauer-Emmett-Teller surface area (BET) surface area of less than 1 square meter per gram.

The reaction gas is preferably an alkane or mixture of alkanes. Examples of alkanes are methane, ethane, propane, or a combination thereof. The alkane may be in liquid form at room temperature but should be capable of being in gaseous form as it is introduced into the device 100.

The alkane can be introduced into the reaction chamber along with a carrier gas in a gaseous mixture. The carrier gas is generally an inert gas such as nitrogen, argon, helium and the like. It is desirable for the carrier gas not to comprise hydrogen or oxygen (e.g., water, carbon monoxide or carbon dioxide). The carrier gas is generally present in the gaseous mixture in an amount of 5 to 20 wt %, preferably 7 to 13 wt %, based on the total weight of the gaseous mixture.

In one embodiment, in one method of conducting the reaction, the reactant gas (i.e., the alkane) is introduced into the device at the inlet end of the tubular reactor (also called a tube) (see FIG. 1). An inert carrier gas (e.g., nitrogen) may be introduced into the tube along with the reactant gas. The gaseous mixture may be mixed if desired prior to being introduced into the tube. The optional heating media section or heat exchanger heats the reactant gas to a desired temperature. The reactant gas is then passed to the catalyst bed where it is exposed to the radiation. The radiation then further heats the reactant gas in the presence of the catalyst converting it to a product. The reactants may be subjected to more than one pass through the reactor in order to convert them to products.

When the alkane is methane, the reaction product is generally an alkylene (e.g., ethylene). To achieve the direct conversion of alkanes, it is desirable to cleave the first C—H bond while suppressing further catalytic dehydrogenation, avoiding both carbon dioxide generation and coke deposition. The metal catalyst sites (especially those confined by the lattice and embedded in a metal oxide matrix) activate the alkane in the absence of oxidants, generating methyl radicals, which desorb from the catalyst surface and then undergo a series of gas phase reactions to yield ethylene, hydrogen gas and other higher hydrocarbons (hydrocarbons having higher molecular weights than methane) such as benzene.

The yield in the conversion of methane to alkylenes is greater than 30%, preferably greater than 45% and even more preferably greater than 60%. The use of radiation to effect the conversion is advantageous in that it gives rise to a reaction system that uses gaseous temperatures that are substantially lower than those used in processes that do not employ radiation. Without being limited to theory, the greatest temperatures occur at the catalyst surface when it is subjected to radiation. This might promote radical desorption and would enable one to control the reaction temperature and thus the product distribution independently to some extent. This gives rise to higher yields and higher selectivities of the initially formed C2-hydrocarbons.

### EXAMPLES

The following example is intended to illustrate, and do not limit the teachings of this disclosure.

15.1 grams of 0.5% Fe on silica was prepared as described in the 2014 Science article (ref 1.) and placed in the section of FIG. 1, above as indicated as “110” (surface area <1 m²/g and nominal average particle size of ca. 1 mm). 59.4 g of SiC powder (also surface area <1 m²/g and nominal average particle size of ca. 1 mm) was placed in the section “108”. High purity (94.9+% methane with 5% Ar) was passed at a flow rate of 100 cm³/minute over the SiC powder and catalyst contained within the 0.5 inch Quartz tube reactor. A mass spectrometer (Extor®-300) was connected to the reactor effluent to continuously sample the gas stream from the reactor. The mass spectrometer measured methane (dominant m/e=16) as the single reactant. Exposure to 600 Watts in microwave energy within a CEM® microwave oven with two opposing chokes to allow the reactor tube to pass into and out of the oven and to prevent the microwave radiation from escaping. After an hour of exposure to 600 watts at 2.54 gHz, the production of ethylene increased by over 50% compared to when the microwave exposure was stopped. This was reflected in the increase in the product sampled molecular weight m/e=27 for which ethylene is a maximum in the spectrometer. There is no evidence for production of benzene in this system (m/e=78). Thus exposure to microwaves increases the production and selectivity of methane to ethylene at the estimated temperature of ca. 500° C.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method comprising:
disposing a catalyst composition in a device that comprises:
a microwave radiation cavity
a tubular reactor having an inlet and an outlet disposed in the radiation cavity; where the catalyst composition is disposed in the tube and comprises a transition metal disposed on a support; where the radiation cavity is operative to subject the catalyst composition to microwave radiation;
introducing an alkane into the inlet end of the tube; and
obtaining an alkylene and hydrogen at the outlet end of the tube.

2. The method of claim 1, where the transition metal is iron, nickel, cobalt, titanium, vanadium, chromium, copper, zinc, molybdenum, platinum, tantalum, niobium, gold, silver, palladium, iridium, or a combination thereof.

3. The method of claim 1, where the transition metal is iron, nickel, cobalt, or a combination comprising at least one of the foregoing transition metals.

4. The method of claim 1, where the alkane is introduced into the tube along with an inert carrier gas.

5. The method of claim 4, where the inert gas is argon, nitrogen or helium.

6. The method of claim 1, where the alkane is methane, ethane, propane or a combination thereof.

7. The method of claim 1, where the alkane is methane.

8. The method of claim 1, where the alkylene product is ethylene.

9. The method of claim 1, where a yield in the conversion of alkanes to alkylenes is greater than 30%.

10. The method of claim 1, where a yield in the conversion of alkanes to alkylenes is greater than 50%.

11. The method of claim 1, where a yield in the conversion of alkanes to alkylenes is greater than 60%.

12. The method of claim 1, further comprising preheating the alkane before it contacts the catalyst composition.

13. A device comprising:
a radiation cavity
a tube having an inlet and an outlet disposed in the radiation cavity; where the catalyst composition is disposed in the tube and where the catalyst composition comprises a transition metal disposed on a support; where the radiation cavity is operative to subject the catalyst composition to microwave radiation, radio frequency radiation, or a combination thereof;
a heating media section disposed inside the tube; and
a radiation barrier disposed between the radiation cavity and the tube; where the radiation barrier is effective to prevent radiation leakage from the device.

14. The device of claim 13, where the heating media section is a heat exchanger.

15. The device of claim 14, where the heat exchanger is a feed-effluent heat exchanger.

16. The device of claim 13 where the heating is accomplished indirectly by employing a media heated by the radiation within the cavity.

17. The device of claim 13, where the device is effective to convert an alkane to an alkylene.

18. The device of claim 17 where the alkane is methane and the alkylene is ethylene.

19. A device of claim 13, where multiple tubes operating in parallel are employed within the cavity.
Reference 1: X. Guo et al. Science 9 May 2014: Vol. 344 no. 6184 pp. 616-619
